(19) United States
(12) Patent Application Publication
(10) Pub. No.: US 2012/0159378 A1
(43) Pub. Date: Jun. 21, 2012

(54) METHODS AND SYSTEMS FOR SUGGESTING POTENTIAL INPUTS IN A TEXT-BASED REPORT GENERATION APPLICATION

(76) Inventors: David Scott Grassl, McFarland, WI (US); Jonathan Michael Levin, Fox Point, WI (US)

(21) Appl. No.: 13/253,318

(22) Filed: Oct. 5, 2011

Related U.S. Application Data
(60) Provisional application No. 61/424,356, filed on Dec. 17, 2010.

(51) Int. Cl. G06F 3/048

(52) U.S. Cl. 715/780

(57) ABSTRACT

Systems, methods, and computer-readable medium encoded with a plurality of processor-executable instructions for providing a list of potential inputs to a user in response to a prompt presented to the user. One system includes a processor, a database connected to the computer processor and storing information relating to at least one potential input associated with each of a plurality of potential prompts, and a first application stored in non-transitory computer readable medium accessible and executable by the processor. The first application is configured to automatically determine an active location on a text-based form presented to a user by a second application, determine a prompt presented to the user on the text-based form based on the determined active location, generate a list of potential inputs for the determined prompt based on the determined prompt and the information stored in the database, and present the list of potential inputs to the user.

### RELATED APPLICATIONS

This application claims priority to U.S. Provisional Patent Application No. 61/424,356, filed Dec. 17, 2010, the entire contents of which are hereby incorporated by reference.

### FIELD OF THE INVENTION

Embodiments of the invention relate to systems, methods, and computer-readable medium encoded with instructions for aiding the completion of a form presented by a report generation application.

### BACKGROUND OF THE INVENTION

Physicians, such as radiologists, spend many hours creating imaging reports outlining their findings and analysis of a particular medical study. Many physicians use report generation applications to aid in the completion of imaging reports. Report generation applications, such as radiology report generation applications, present a physician with a text-based report template or editor that includes various prompts (e.g., descriptions, categories, labels, questions, etc.) that specify the information needed or desired to complete a particular report for a particular study. The report generation applications can be preinstalled with one or more report templates and/or may allow a user to define, import, or modify a report template to create individualized report formats for various types of studies.

Physicians often dictate their findings into a report template using a dictaphone or similar device. Physicians can also use the functions of the handheld component included with or separate from the dictaphone to navigate within a report template. For example, a physician can say “next,” “tab,” “previous,” or a similar instruction into a dictaphone to move to a different prompt included in the displayed report template. Physicians may also use buttons included on the dictaphone to navigate within a report template.

Once the report template is completed by a physician, the report generation applications store and/or forward the completed text-based report to a report management application or database or to additional medical personnel for further review and/or processing (e.g., billing). The text-based form of the report allows the report to be accessed by various personnel using various software programs and prevents accessibility and storage issues often related with stored information.

### SUMMARY OF THE INVENTION

Although each medical study differs, there are efficiencies and advantages to creating uniformity within and across physicians and the reports they create. For example, a particular physician may want to use similar phrases when dictating studies to make his or her reports consistent and efficient. Similarly, a hospital or hospital network may want their physicians to use similar phrases when dictating studies to make reports consistent regardless of what physician completed the report. In addition, insurance companies and billing and collection entities may want particular phrases and terminology used to ensure proper processing of reports for payment purposes.

Currently, to provide consistency and efficiency, physicians often make and use a separate listing (e.g., a hardcopy listing or an electronic file containing a listing) that they dictate from. These separate listings, however, are cumbersome to use as multiple computer systems or separate paper copies must be used during generation of a report. Furthermore, if a physician misplaces the separate listing or is working somewhere they cannot access the separate listing, the physician may enter incorrect information. Furthermore, the listing used by the physician must be manually updated and, therefore, may quickly become out-dated. Also, if a physician reads the listing incorrectly or misspeaks during dictation, the resulting report may contain incorrect and/or inconsistent information.

Accordingly, embodiments of the invention provide a system for providing a list of potential inputs to a user in response to a prompt presented to the user. The system includes a processor, a database connected to the computer processor and storing information relating to at least one potential input associated with each of a plurality of potential prompts, and a first application stored in non-transitory computer readable medium accessible and executable by the processor. The first application is configured to automatically determine an active location on a text-based form presented to a user by a second application, determine a prompt presented to the user on the text-based form based on the determined active location, generate a list of potential inputs for the determined prompt based on the determined prompt and the information stored in the database, and present the list of potential inputs to the user.

Embodiments of the invention also provide a computer-implemented method for providing a list of potential inputs to a user in response to prompt presented to the user. The method includes determining, by a processor, an active location on a text-based form presented to a user by a report generation application and a prompt presented to the user on the text-based form based on the determined active location. The method also includes generating, by the processor, a list of potential inputs based on the determined prompt, and presenting, by the processor, the list of potential inputs to the user.

In addition, embodiments of the invention provide non-transitory computer-readable medium encoded with a plurality of processor-executable instructions. The instructions are for determining an active location on a text-based form presented to a user by a report generate application, determining a prompt presented to the user on the text-based form based on the determined active location, generating a list of potential inputs based on the determined prompt, presenting the list of potential inputs to the user, receiving a selection of an input from the list of potential inputs from the user, and inserting the selected input to the text-based form as plain text.

Other aspects of the invention will become apparent by consideration of the detailed description and accompanying drawings.

### BRIEF DESCRIPTION OF THE DRAWINGS

FIG. 1 is a screen shot illustrating a text-based form presented by a report generation application.

FIG. 2 schematically illustrates a system, including an interface application and an editor application, for providing a list of potential inputs to a user in response to a prompt presented to the user by a report generation application.

FIG. 3 schematically illustrates the interface application of FIG. 2 interacting with a report generation application.

FIG. 4 is a flow chart illustrating a method performed by the interface application of FIG. 2 to present a list of potential inputs to a user.

FIG. 5 is a screen shot illustrating a list of potential inputs presented to a user within a report generation application.

FIGS. 6-7 are a flow chart illustrating the method of FIG. 4 in more detail.

FIG. 8 is a flow chart illustrating a method performed the interface application of FIG. 2 to insert selected input into a text-based form presented by a report generation application.

FIG. 9 is a screen shot illustrating input selected from a list presented by the interface application of FIG. 2 inserted into a text-based form presented by the report generation application of FIG. 3.

FIG. 10 is a screen shot illustrating a menu presented to a user by the interface application of FIG. 2 that allows the user to perform checks on a text-based form presented by the report generation application.

FIG. 11 is a screen shot illustrating a dual phrases check performed by the interface application of FIG. 2.

FIG. 12 is a screen shot illustrating a negative phrases check performed by the interface application of FIG. 2.

FIG. 13 is a screen shot illustrating a list editor presented to a user by the interface application of FIG. 2 that allows the user to edit a list of potential inputs presented to a user in response to a particular prompt.

FIG. 14 is a screen shot illustrating a study editor presented to a user by the editor application of FIG. 2 that allows the user to edit a study and/or report templates.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium). As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

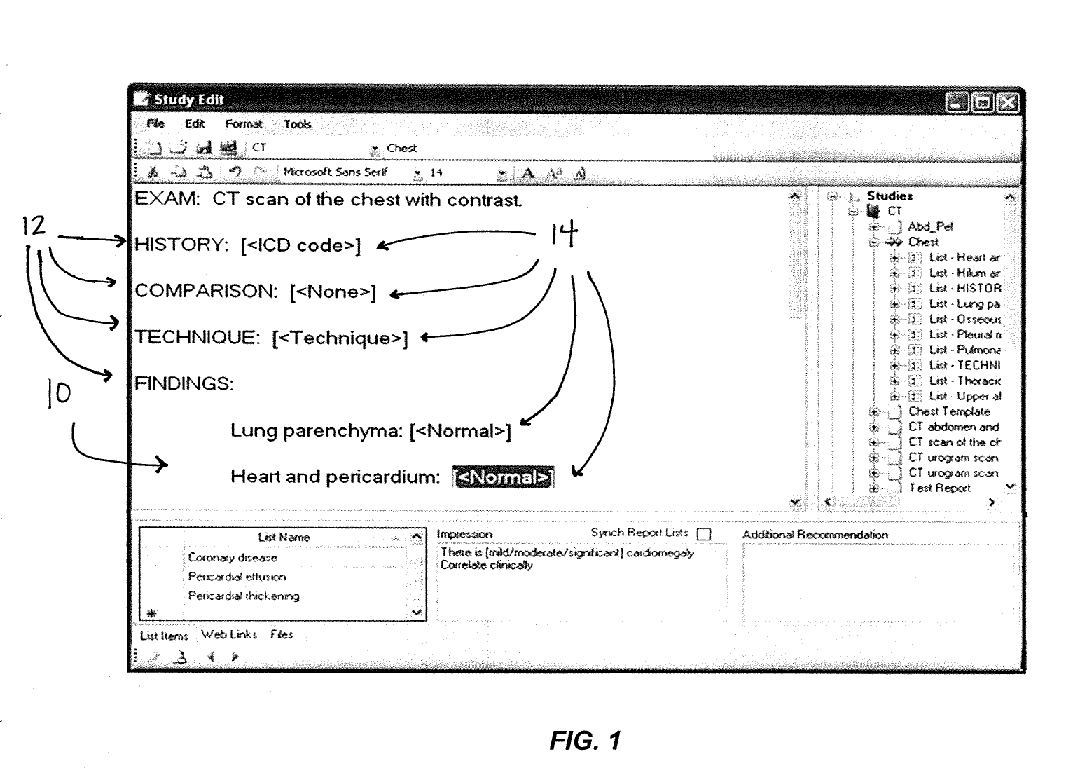

FIG. 1 is a screen shot illustrating a form 10 presented by a report generation application. The form 10 is text-based, which generally means that the form 10 contains plain text and the input to and output from the form 10 is plain text as compared to graphics or objects. The form 10, however, many include portions that are not text-based and/or may be included with other screens, windows, menus, or sections that are not text-based. The report generation application can present the form 10 in a text editor that allows a user to enter, delete, and modify text in the form 10.

As shown in FIG. 1, the form 10 includes one or more prompts 12. The prompts 12 may be in the form of a description, category, label, or question that informs a user what information should be input to the form 10. Each prompt 12 can include a placeholder 14 that is replaced with text when a user enters (e.g., dictates or types) information in response to the prompt 12. As described above, a user can also dictate commands to the report generation application to move between the prompts 12. A particular prompt 12 can be marked as active by highlighting the placeholder 14 associated with the prompt 12. For example, the placeholder 14 including the text “[<Normal>]” is highlighted in FIG. 1, which informs the user that the corresponding prompt 12 including the text “Heart and pericardium:” is currently active. Any information input by the user will be inserted into the report 10 at the active prompt and will replace the highlighted placeholder 14. In some embodiments, a prompt 12 can be marked as active by highlighting the prompt 12 in addition to or in place of highlighting the placeholder 14.

As described above, physicians often keep a separate listing of phrases and terminology for one or more of the prompts 12 included in various types of reports or forms 10. Physicians read from the separate listing while dictating a report to provide correct and consistent information in their reports. However, as mentioned above, there are various drawbacks associated with using separate listings, such as keeping lists up-to-date and mis-speaking inputs included in the separate listing.

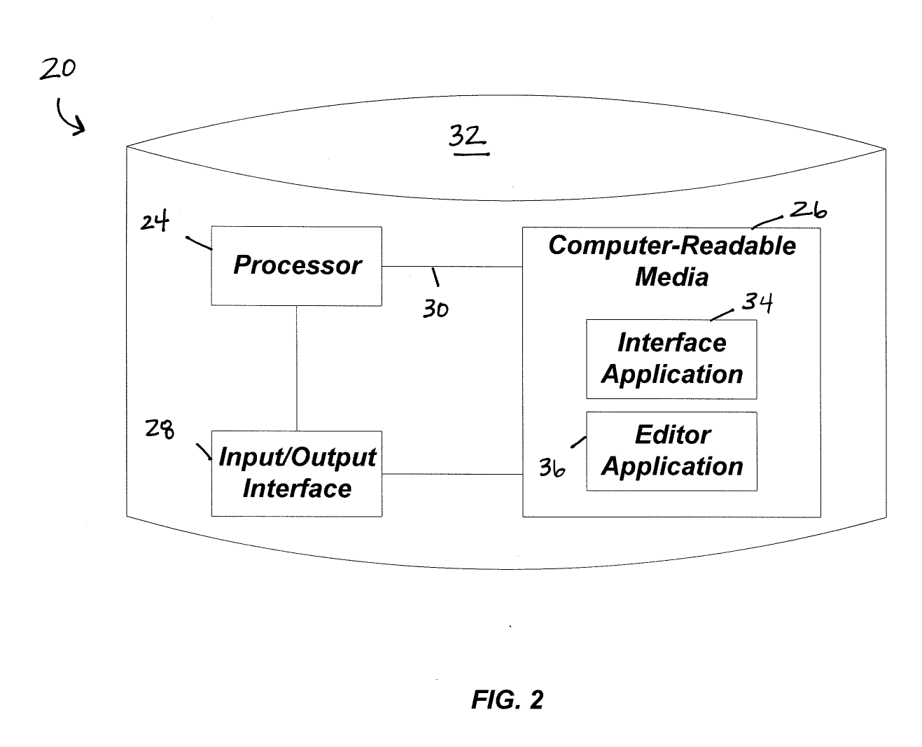

FIG. 2 schematically illustrates a system 20 for providing a list of potential inputs to a user in response to a prompt presented to the user within a report generation application. It should be understood that FIG. 2 illustrates only one example of components of a system 20 and that other configurations are possible. As shown in FIG. 2, the system 20 includes a processor 24, computer-readable media 26, and an input/output interface 28. The processor 24, computer-readable media 26, and input/output interface 28 are connected by one or more connections 30, such as a system bus. It should be understood that although the processor 24, computer-readable media 26, and input/output interface 28 are illustrated as part of a single server or another computing device 32 (e.g., such as a workstation or personal computer), the components of the system 20 can be distributed over multiple servers or computing devices. Similarly, the system 20 can include multiple processors 24, computer-readable media 26, and input/output interfaces 28.

The processor 24 retrieves and executes instructions stored in the computer-readable media 26. The processor 24 can also store data to the computer-readable media 26. The computer-readable media 26 can include non-transitory computer readable medium and can include volatile memory, non-volatile memory, or combinations thereof. In some embodiments, the computer-readable media 26 includes a disk drive or other types of large capacity storage mechanisms. The computer-readable media 26 can also include a database structure that stores data processed by the system 20 or otherwise obtained by the system 20.

The input/output interface 28 receives information from outside the system 20 and outputs information outside the system 20. For example, the input/output interface 28 can include a network interface, such as an Ethernet card or a wireless network card, that allows the system 20 to send and receive information over a network, such as a local area network or the Internet. In some embodiments, the input/output interface 28 includes drivers configured to receive and send data to and from various input and/or output devices, such as a keyboard, a mouse, a printer, a monitor, etc.

The instructions stored in the computer-readable media 26 can include various components or modules configured to perform particular functionality when executed by the processor 24. For example, as illustrated in FIG. 2, the computer-readable media 26 includes an interface application 34 and an editor application 36. In some embodiments, when the computer-readable media 26 is part of a workstation or personal computer of a user, the media 26 may also include a report generation application. As described in more detail below, the interface application 34 interacts with a report generation application to determine and display a list of potential inputs for a currently active prompt displayed to the user in a text-based form. As also described in more detail below, the editor application 36 allows a user to modify the text-based forms presented by the report generation application.

It should be understood that in some embodiments the computing device 32 can represent a workstation or personal computer operated by a user to store and execute the interface application 34 and/or the editor application 36. However, in other embodiments, the computing device 32 can represent a server that hosts the interface application 34 and/or the editor application 36 as network-based tools or applications. Therefore, a user can access the interface application 34 and the editor application 36 through a network, such as the Internet. Accordingly, in some embodiments, a user is not required to have the interface application 34 or the editor application 36 permanently installed on their workstation or personal computer. Rather, the user can access the applications 34, 36 using a browser application, such as Internet Explorer® or Firefox®. For example, the applications 34, 36 can include ClickOnce® web-based applications, as provided by Microsoft®.

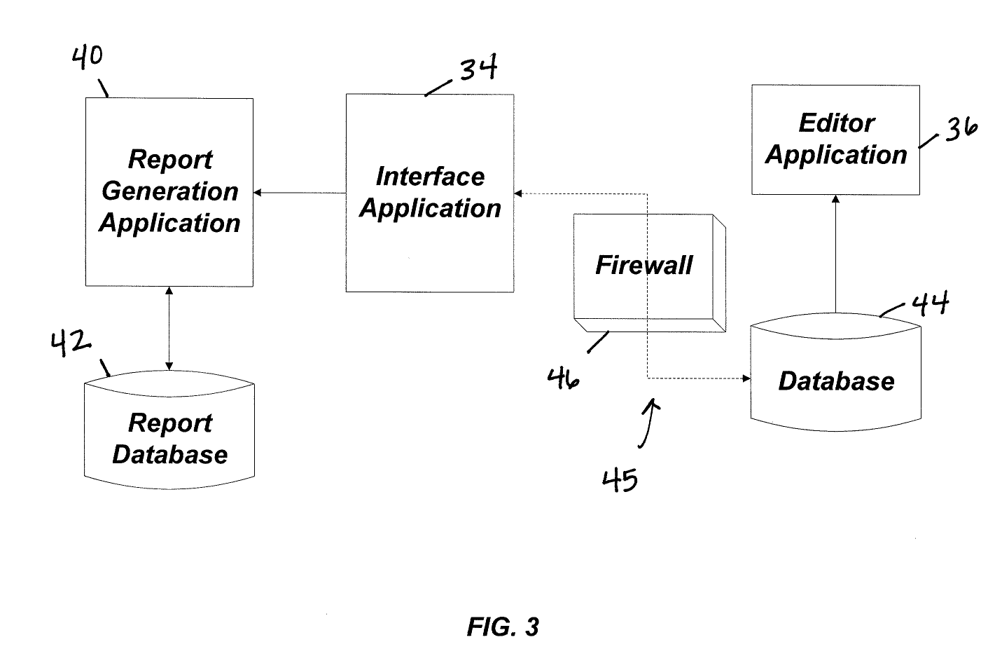

FIG. 3 schematically illustrates the interface application 34 and the editor application 36 interacting with a report generation application 40. As described above, the report generation application 40 presents the text-based form 10 to a user and allows the user to enter text into the form 10. In some embodiments, the report generation application 40 includes an imaging report generation dictation application, such as PowerScribe® provided by Nuance Communications, Inc. It should be understood, however, the report generation application can include other types of applications, including non-dictation imaging report generation applications and non-imaging applications. For example, the report generation application can include a police report generation application or a proprietary report generation application for a specific organization.

As shown in FIG. 3, the report generation application 40 interacts with a report database 42. The report database 42 can store various report templates that the application 40 can use to generate a text-based form 10 to display to a user. In some embodiments, the report database 42 can also store completed reports. Completed reports can also be stored to other data storage locations, such as a radiology information system (“RIS”), a picture archiving and communication system (“PACS”), or both. The database 42 can also store transcription data and related applications (e.g., voice models, language models, etc.) that convert spoken text dictated by a user into text to be inserted into the form 10.

As described in more detail below, the interface application 34 interacts with the report generation application 40 to determine and present a list of potential inputs to a user completing a report using the report generation application 40. The interface application 34 can access one or more databases 44 to retrieve potential inputs for a particular prompt presented to a user. The database 44 can store a set of potential prompts displayed to a user by the report generation application 40 and one or more potential inputs associated with each prompt. In some embodiments, the database 44 is included in the computer-readable media 26. The interface application 34 can access the database 44 over one or more networks 45, such as a local area network or the Internet. One or more network security devices or applications, such as a firewall 46, can be used to protect access to the database 44. Storing the potential inputs on the database 44 accessed remotely by the interface application 40 allows multiple users to access and share a common collection of potential inputs. Similarly, storing the potential inputs on a database 44 accessible by multiple users allows updated inputs to be simultaneously available to multiple users.

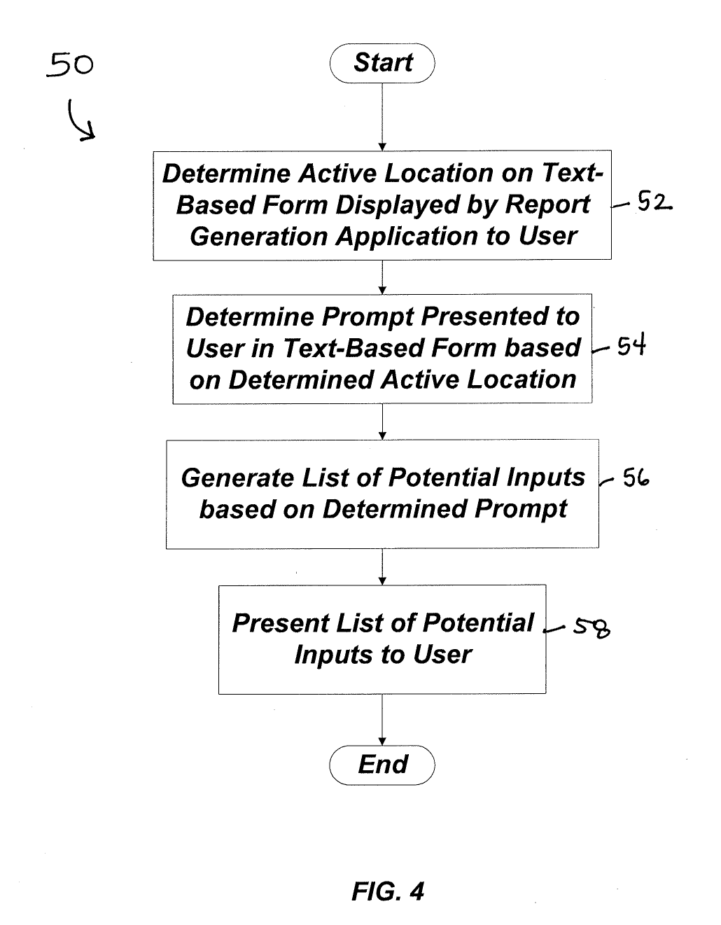

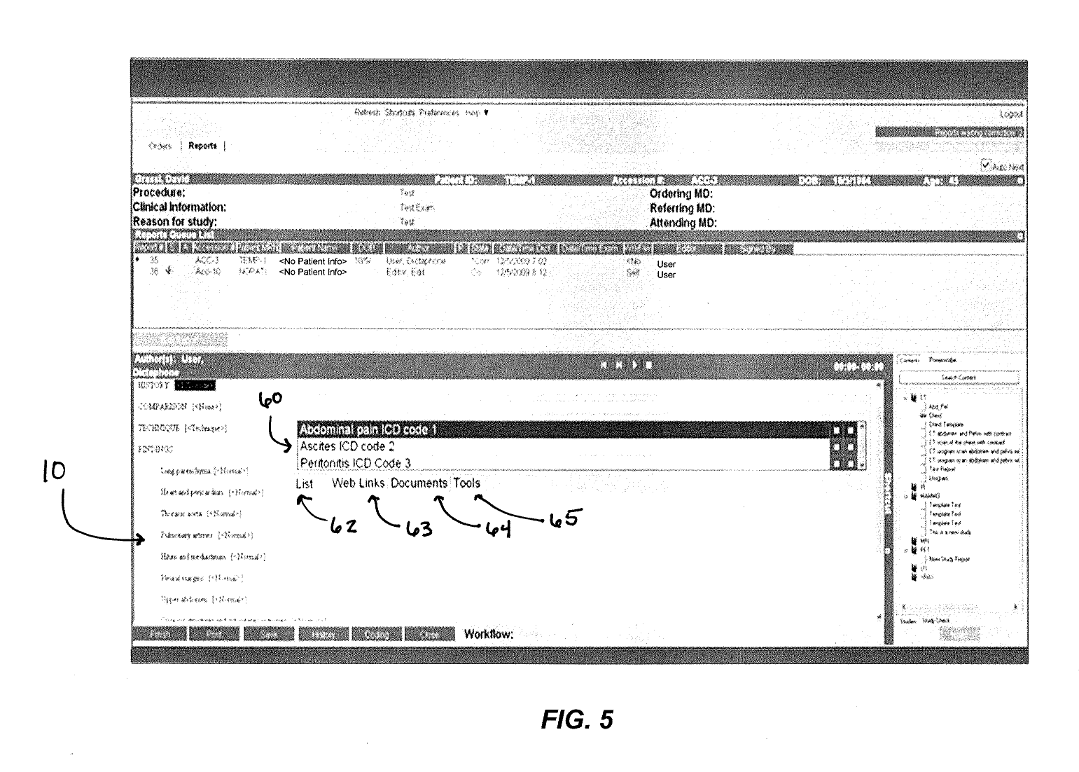

FIG. 4 is a flow chart illustrating a method 50 performed by the interface application 34 to present a list of potential inputs to a user in response to a current prompt presented to the user by the report generation application 40. It should be understood that the method 50 is performed by the interface application 34 after the report generation application 40 and the interface application 34 have already been executed or accessed by the user. Once a user has executed both applications, the interface application 34 determines an active location on the text-based form 10 displayed by the report generation application 40 (at 52). The interface application 34 then determines a prompt 12 associated with the active location (at 54), and generates a list of potential inputs based on the determined prompt (at 56). The interface application 34 then presents the generated list of potential inputs to the user (at 58). FIG. 5 is a screen shot illustrating a list of potential inputs 60 presented to a user by the interface application 34. As shown in FIG. 5, the list 60 is displayed in a window overlaying the text-based form 10. In some embodiments, the interface application 34 determines a location for displaying the list 60 based on the determined active location. For example, the interface application 34 can display the list 60 close to the active location but not covering the active location, which allows the user to view both the active location and the list 60. In some embodiments, the list 60 is displayed as a drop-down list or menu.

As shown in FIG. 5, the list 60 can be presented to the user in a non-text-based form. For example, the list 60 can include various objects that the user can manipulate to review the potential inputs and make a decision regarding what input to choose. In some embodiments, the list 60 can include one or more tabs, buttons, or other selection mechanisms that allow the user to access other information than just the potential inputs. As shown in FIG. 5, the list 50 can include a list selection mechanism 62, a links selection mechanism 63, a documents selection mechanism 64, and a tools selection mechanism 65. A user can select the links selection mechanism 63 to access a listing of one or more links to networked documents, such as web pages, that provide useful information related to one or more of the potential inputs, the active prompt, or the type of study for which the report is being generated. For example, if the user is completing a report for a brain study and is entering information about the anatomy of the brain, the user may select the links selection mechanism 63 to access an online, web-based human brain anatomy tutorial. Therefore, the links can be customized based on the type of template the user is working in, the active prompt or placeholder, and/or potential inputs included in the list 60. The links provided by the interface application 34 after the user selects the links selection mechanism 63 may be presented in the same window as the list 60 or in a separate window. The provided links may also include hyperlinks that the user can select to directly access the linked information.

Similarly, the user can select the documents selection mechanism 64 to access one or more documents, such as an article discussing lung diseases or instructions for performing certain measurements or analysis of an image. As compared to the links selection mechanism 63, selecting the documents selection mechanism 64 takes the user directly to one or more stored documents (e.g., stored locally on the user's workstation or personal computer and/or stored on the database 44). The documents provided by the interface application 34 after the use selects the links selection mechanism 63 may be presented in the same window as the list 60 or in a separate window. Similarly, if there are multiple documents available for a particular prompt, the interface application 34 can initially display a listing of available documents and allow the user to select which document to view.

The user can also select the tools selection mechanism 65 to access one or more tools, such as a calculator, a dictionary, a thesaurus, an anatomy model or reference, etc. The tools provided by the interface application 34 after the use selects the tools selection mechanism 65 may be presented in the same window as the list 60 or in a separate window. Similarly, if there are multiple tools available for a particular prompt, the interface application 34 can initially display a listing of available tools and allow the user to select which tool to use. If the user has selected the links, documents, or tools selection mechanism and wants to return to the list 60, the user can select the list selection mechanism 62.

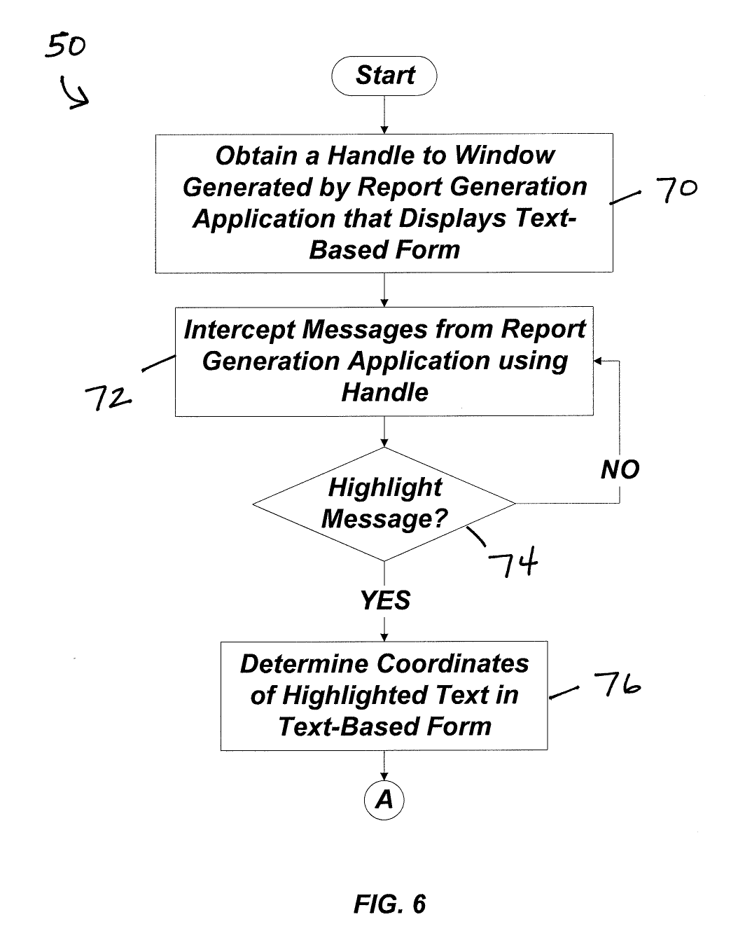

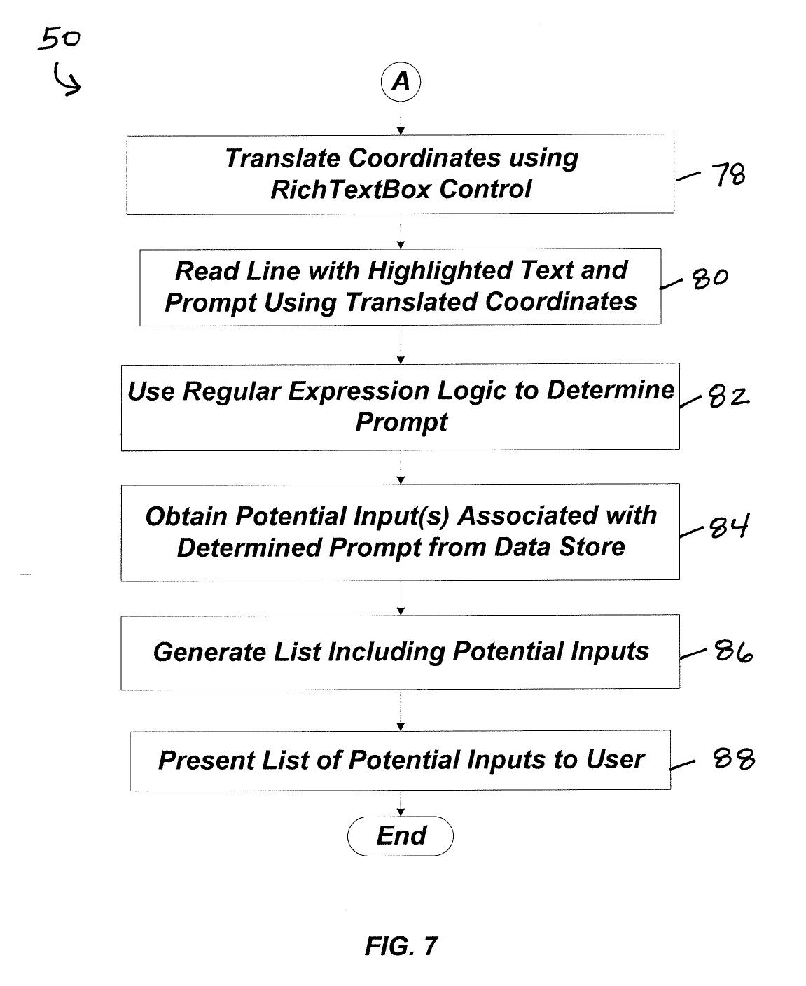

FIGS. 6-7 are a flow chart illustrating the method 50 in more detail. In particular, FIGS. 6-7 illustrate how the interface application 34 determines an active location on the text-based form 10 (see 52 in FIG. 4), determines a prompt 12 associated with the active location (see 54 in FIG. 4), generates a list of potential inputs based on the determined prompt (see 56 in FIG. 4), and presents the generated list of potential inputs to the user (see 58 in FIG. 4). Again it should be understood that the method 50 is performed by the interface application 34 after the report generation application 40 and the interface application 34 (e.g., through ClickOnce®) have already been executed or accessed by the user. As shown in FIG. 6, to determine a list 60 for a particular report, the interface application 34 identifies the report generation application 40 running within the user's computing environment. Therefore, in a Windows® environment, the application 34 searches all windows handled by the user's workstation or personal computer to find the window generated by the report generation application 40 that displays the text-based form 10. Once the interface application 34 finds the appropriate window, the application 34 obtains a reference (e.g., a pointer or a handle, as used in the Microsoft® Windows® environment) to the window (at 70). In some embodiments, the interface application 34 includes a Microsoft®.Net® WinForm software application and the report generation application 40 includes a Java® web program executing in a Windows® environment. Therefore, the interface application 34 can use Windows® hooking and subclassing functionality (described in more detail below) to interface with the report generation application 40 once the interface application 40 has a reference (i.e., a handle) to the window containing the form 10. In some embodiments, the reference to the window generated by the report generation application 40 is a unique address of the window containing the text-based form 10.

As described above, when a user uses a dictaphone to move or “tab” through the form 10, the report generation application 40 highlights the currently active placeholder 14, represented as text between square brackets “[sample text].” To know what placeholder is currently active, the interface application 34 “subclasses” the window using the reference (e.g., the handle) previously obtained. Once the interface application 34 “subclasses” the window containing the form 10, the interface application 34 intercepts messages or commands issued for the window (at 72). When a particular placeholder 14 is to be marked as active, the window will receive a highlight instruction that instructs the window to refresh and highlight particular text contained in the form. Therefore, the interface application can intercept messages and determine whether the intercepted message includes a highlight instruction (e.g., WM_PAINT) (at 74).

When an intercepted message includes a highlight instruction, the interface application 34 determines the physical coordinates of the highlighted text (i.e., the active placeholder 14) in the form 10 (at 76). In some embodiments, the interface application 34 uses the reference to the window containing the form 10 and operating system procedures (e.g., operating system API calls) to obtain the coordinates of the highlighted text (e.g., Windows® low level program calls outside the .NET programming language).

In some embodiments, because the coordinates were obtained using low level system calls, the obtained coordinates may be in a different coordinate layout than the form 10. In addition, there may be special characters within the highlighted text that need to be accounted for to get an accurate reading of what text is highlighted. Therefore, as shown in FIG. 7, after the interface application 34 determines the coordinates of the highlighted text, the application 34 can create an object to translate the coordinates (at 78). For example, within the Windows® environment, the interface application 34 can create a RichTextBox control to translate the coordinates.

The interface application 34 uses the translated coordinates to determine the coordinates of the line of the form 10 that contains the highlighted text. Once the interface application 34 knows the line of the form 10 containing the highlight text, the interface application 34 can read or extract that line from the form (at 80). The extracted line includes the highlighted text and the corresponding prompt 12.

The interface application 34 then applies an algorithm to the extracted text to determine the prompt included in the text (at 82). For example, the interface application 34 can use an algorithm that applies regular expression logic, which is a text-based set of routines that translates text into any pattern, to the extracted text to determine the prompt. In some embodiments, the interface application 34 uses the regular expression logic to look for a pattern in the extracted text that identifies an index or list tag associated with the prompt. The pattern can be “\b\w {2,30} \b.” The “\b” in this pattern represents a space. Therefore, the pattern can be used to identify a word in the extracted text that includes a space before the word and a space after the word. The “\w{2,30}” in this patterns represents a word 2 to 30 characters long. Therefore, the pattern can be used to identify a 2 to 30 character word in the extracted text that includes a space and after. Using this pattern excludes special characters and single word qualifies, which eliminates any minor deviations in the index phrase. For example, regardless of whether a word is followed by a comma, a colon, or a semi-colon (e.g., “Lung parenchyma,” “Lung parenchyma,” and “Lung parenchyma;”), using the pattern ensures the word indexes to the same prompt (i.e., “Lung parenchyma”).

Once the prompt or index is determined, the interface application 34 accesses the database 44 to obtain one or more potential inputs associated with the determined prompt or index (at 84). As previously described, the database 44 stores a set of potential prompts and one or more potential inputs associated with each potential prompt. Therefore, the interface application 34 can access the database 44 and search for a stored potential prompt that matches or corresponds with the determined prompt or index. Once a match is found, the interface can obtain the stored potential inputs associated with the matching potential prompt. The interface application 34 then generates a list 60 and populates the list with the potential inputs obtained from the database 44 (at 86) and presents the list 60 to the user (at 88). As illustrated in FIG. 5, the list 60 can be formatted as a window overlaying the window containing the form 10. In some embodiments, the interface application 34 displays the window containing the list 60 at a particular location. For example, the interface application 34 can use the coordinates of the highlighted text and the number of items contained in the list 60 to determine a location for displaying the list 60 that allows the user to view both the highlighted text and the potential inputs included in the list 60.

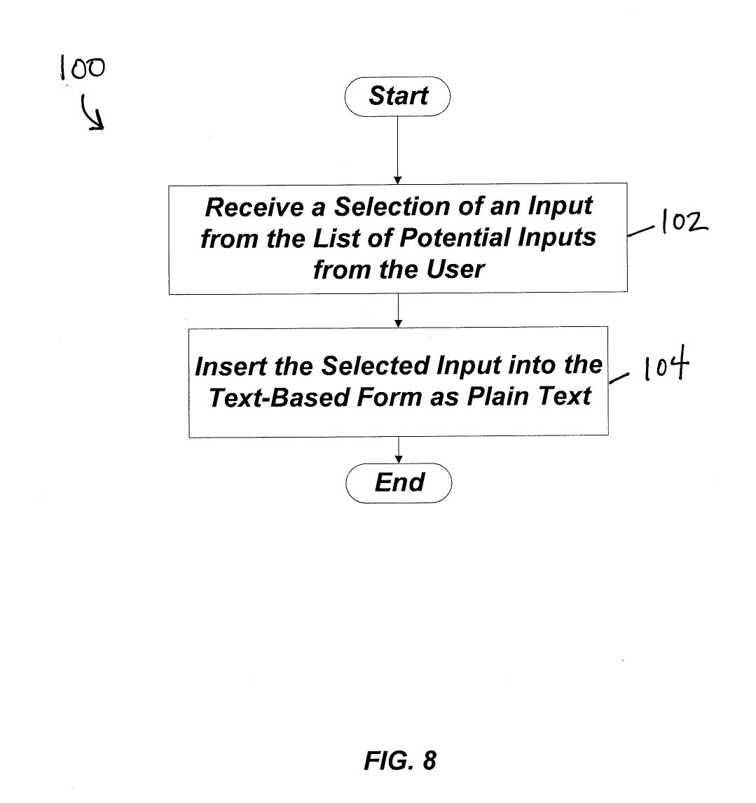

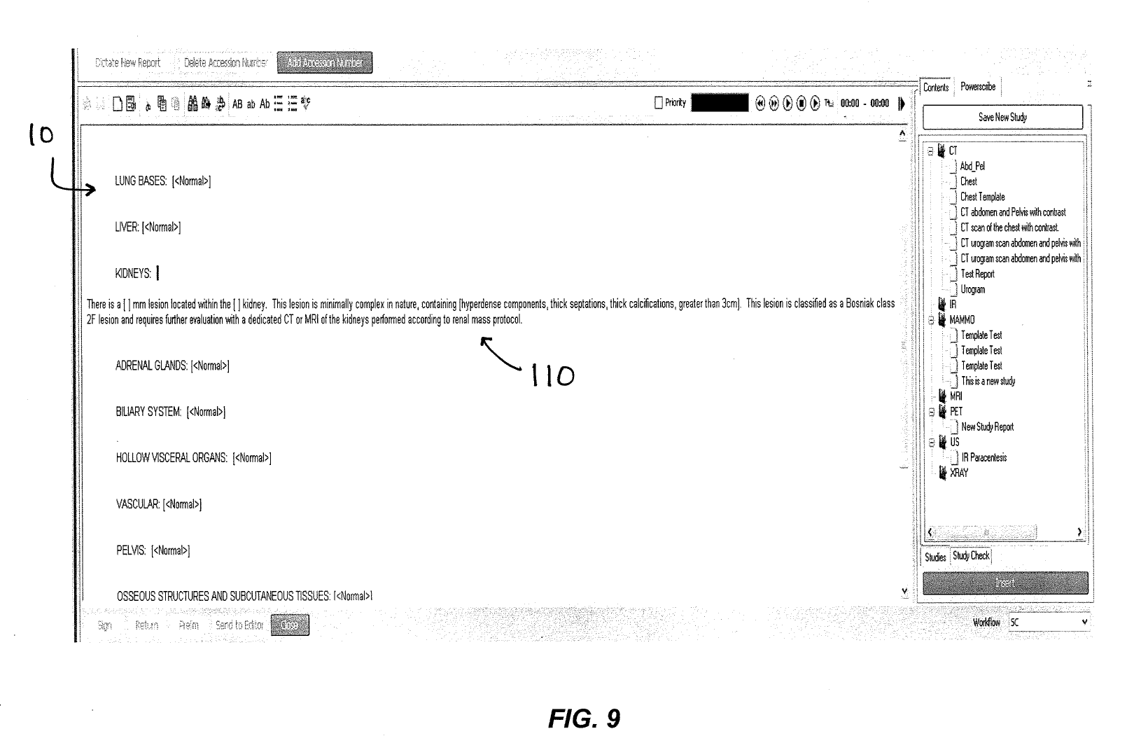

Once the list 60 is displayed to the user, the user can select a potential input for insertion into the form 10. FIG. 8 is a flow chart illustrating a method 100 performed by interface application 34 to insert selected input into the text-based form 10. As shown in FIG. 8, the interface application 34 receives a selection of a potential input from the user within the list 60 (at 102). The selection from the user can be in the form of one or more clicks on a particular input included in the list 60, a selection of a radio box or check box associated with a particular input included in the list 60, etc. When the interface application 34 receives the user's selection, the interface application 34 inserts the selected input into the text-based form 10 as plain text (at 104). As described above, reports generated by the report generation application 40 are text-based reports, which allows the reports to be managed by a document management system, such as a RIS. For example, many RISs will not accept reports with special characters (e.g., such as mark-up or embedded objects). Therefore, any text inserted in the form 10 must be text-based. FIG. 9 is a screen shot illustrating selected input 110 inserted into a text-based form 10 presented by a report generation application 40. In some embodiments, after the interface application 34 inserts the selected into the form 10, the interface application 34 closes the list 60. In other embodiments, the interface application 34 closes a displayed list 60 only when the user moves or tabs to a different prompt 12.

For example, in one embodiment, the report generation application 40 and the interface application 40 are executed within a Windows® environment. Therefore, to get a reference to the report generation application, the interface application 34 enumerates all window handles that are active in the user's operating system. The interface application 34 then looks at each window handle to get the class of that window. The interface application 34 compares the class of each window to a predefined class name (e.g., a class name stored a configuration file associated with the interface application). When the class name of a current window handle matches the predefined class name, the interface application 34 exits the enumeration routine and stores the current window handle. The following pseudo code illustrates this process according to one embodiment of the invention:

FIND report generation window handle

ENUMERATE all window handles
IF window class = config.classname THEN

HOOK window class
EXIT enumeration

The interface application 34 also passes the current window handle to the hook application programming interface (“API”). Once the handle has been passed to the hook API, the interface application 34 can monitor messages sent to the window handle, which enables the interface application 34 to trigger an event when the WM_PAINT message is intercepted. The WM_PAINT message indicates that some text is highlighted in the report generation application 40. When the interface application 34 intercepts this message, the application 34 reads the text in the highlighted area to determine if the highlighted text is an index for a list. For example, as described in more detail below, if the highlighted text begins and ends with predetermined delimiters (e.g., as defined in the interface application's configuration file), the text is used to generate a list of potential inputs. The following pseudo code illustrates this process according to one embodiment of the invention:

RAISE EVENT reportgeneration.windowhandle.WM_PAINT

IF reportgeneration.windowhandle.text begins with index
delimiter AND reportgeneration.windowhandle.text ends
with index delimiter THEN

FIND LIST (pass highlighted text)

As noted above, to make the interface application 40 compatible with different types of report generation applications or radiology information systems (“RISs”), the interface application 40 can use plain or cleaned text to perform indexing. For example, when the highlighted text is passed to the LIST routine (see pseudo code above), the LIST routine removes special characters and single character words and spaces from the text. The routine then compares the cleaned text to a list of indexes in a database. In some embodiments, indexes for specific types of reports are stored separately in the database. When the cleaned text is matched to an index, the items for that index are loaded into a list box, which is displayed to the user. When the user selects an item from the list, the corresponding text (i.e., the impression) for the selected item and any additional text is inserted into the report. The following pseudo code illustrates this process according to one embodiment of the invention:

FIND LIST FUNCITON (highlighted text)

SET Indextext = RemoveUnwantedCharacters(highlighted text)
LOOKUP Indextext in Database
IF IndexText FOUND

THEN DISPLAY LIST

ELSE

EXIT and indicate list not found

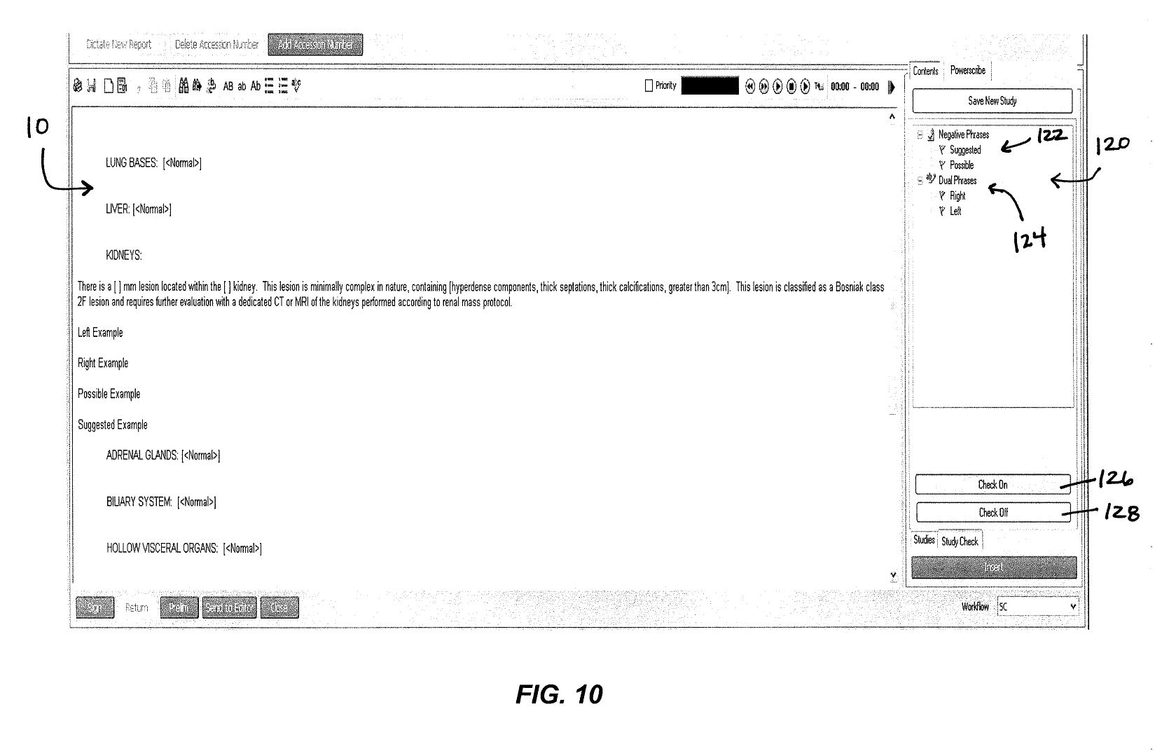

It should be understood that the interface application 34 can perform functionality in addition to displaying lists 60 and inserting selected text into the form 10. In some embodiments, the interface application 34 also allows the user to perform various checks on the text included in the form 10. For example, FIG. 10 is a screen shot illustrating a menu 120 presented to a user by the interface application 34. The menu 120 allows the user to perform checks on a text-based form 10 presented by the report generation application 40. The menu 120 is generated by the interface application 34 and can be displayed by the interface application 34 overlaying the window generated by the report generation application 40 containing the form 10.

As shown in FIG. 10, the menu 120 includes a negative phrases selection mechanism 122 and a dual phrases selection mechanism 124. The menu 120 also includes a check-on selection mechanism 126 and a check-off selection mechanism 128. Once a user selects a particular check to be performed, the user can select the check-on selection mechanism 126 to run the check and can select the check-off selection mechanism 128 to cancel the check. In some embodiments, the checks are automatically performed by the interface application 34 without requiring the user to select the check-on or check-off selection mechanisms 126, 128. In other embodiments, a user can select the check-on selection mechanism 126 once and can perform multiple checks without having to re-select the mechanism 126 for each check.

A user can select the dual phrases selection mechanism 124 to check for phrases in the form 10 that have dual meanings, commonly confused meanings, or contradictory meanings. For example, the terms “left” and “right” are often critical in the analysis of an image and may be confused or improperly used by a physician. For instance, if a physician indicates that surgery is needed on the “left” brain but actually means the “right” brain, future surgery and care of a patient may be performed incorrectly causing disastrous results. Similarly, if a form 10 includes both the phrase “left” and the phrase “right,” there may be a potential issue or mistake. Other phrases with potential “dual” meanings include “cranial” and “caudal,” “carpal” and “tarsal,” “humerus” and “femur,” “metacarpal” and “metatarsal,” and “ascending” and “descending.” When a user selects the dual phrases selection mechanism 124, the interface application 34 scans the text inserted into the form 10 and locates any phrases previously identified as “dual” phrases that require further verification.

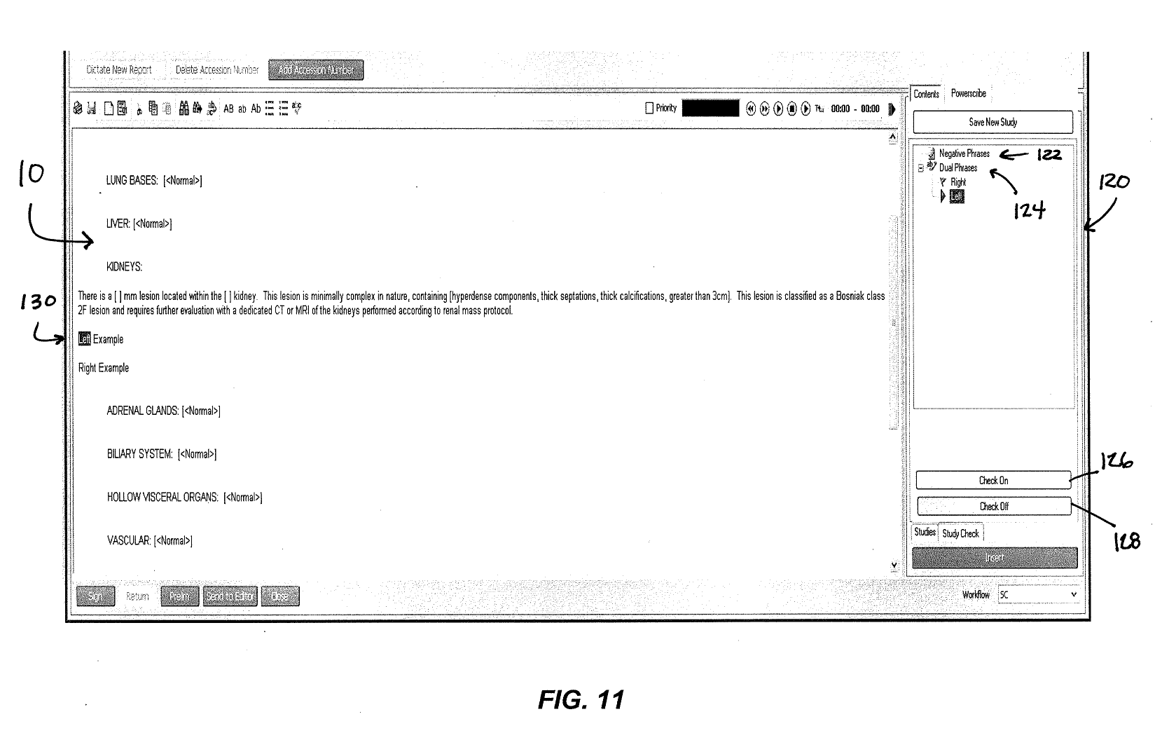

In some embodiments, the user can select the phrases that the interface application 34 should check for at the time the user initiates the dual phrases check. For example, as illustrated in FIG. 10, if a user selects the dual phrases selection mechanism 124, the interface application 34 can display a list of one or more phrases that can be checked. The user can select one or more of the listed phrases and select the check-on selection mechanism 126 (if it is not already selected). The interface application 34 then checks the text contained in the form 10 for the selected phrase(s). FIG. 11 is a screen shot illustrating a dual phrases check performed by the interface application 34 for the phrase “left” selected by the user in the menu 120. As shown in FIG. 11, each time the phrase “left” is found in the form 10, the interface application 34 highlights or otherwise marks (e.g., bolds, underlines, changes font color, etc.) the located phrase in the form 10 (see highlighted text 130). A user can use the dual phrases check to locate, verify, and modify if necessary each use of selected phrase(s) in the form 10.

Similarly, a user can select the negative phrases selection mechanism 122 to check for phrases in the form 10 that should generally be avoided. For example, the terms “suggested” and “possible” may be viewed by insurance companies as indicating that a procedure or treatment is not required or necessary, or be viewed as ambiguous by an opposing attorney in a malpractice lawsuit, resulting in unnecessary liability. Therefore, if a physician indicates that surgery is “suggested,” an insurance company may refuse to pay for the surgery claiming that it is not critical or needed. When a user selects the negative phrases selection mechanism 122, the interface application 34 scans the text inserted into the form 10 and locates any phrases previously identified as negative phrases.

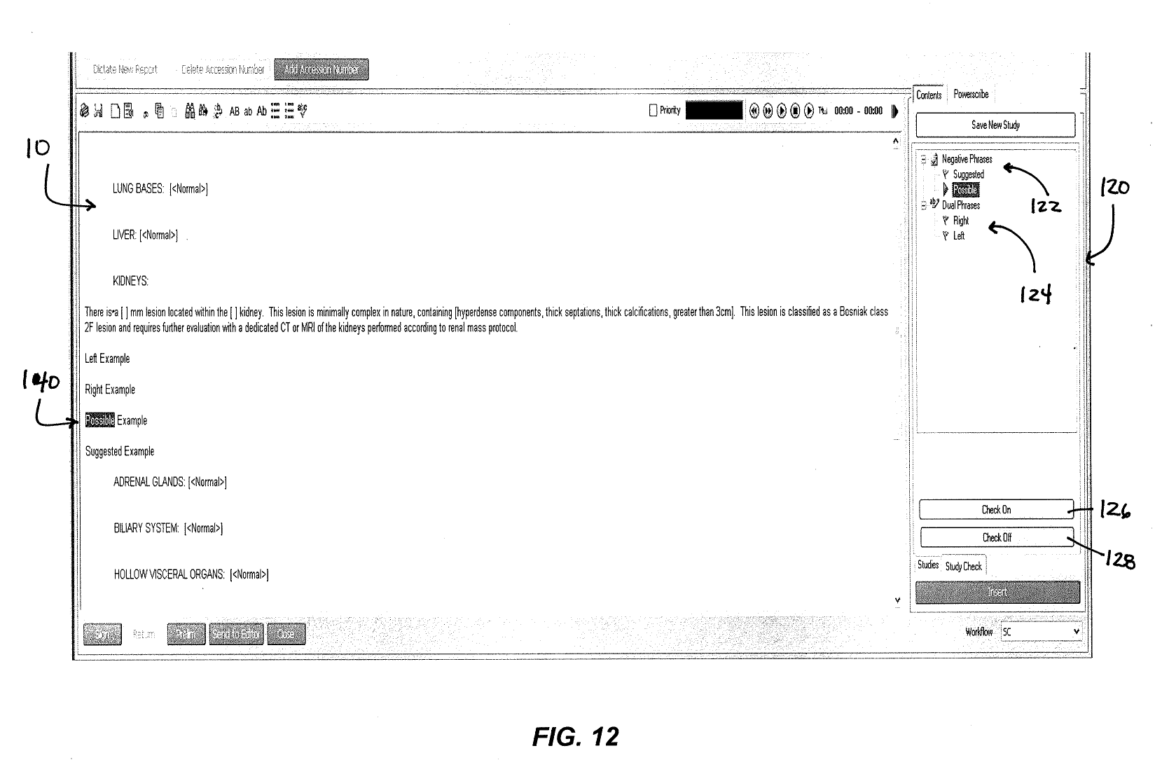

In some embodiments, the user can select the phrases that the interface application 34 checks for at the time the user initiates the negative phrases check. For example, as illustrated in FIG. 10, if a user selects the negative phrases selection mechanism 122, the interface application 34 can display a list of one or more negative phrases that can be checked. The user can select one or more of the listed phrases and can select the check-on selection mechanism 126 (if it is not already turned on). The interface application 34 then checks the text contained in the form 10 for the selected phrase(s). FIG. 12 is a screen shot illustrating a negative phrases check performed by the interface application 34 for the phrase “suggested” selected by the user in the menu 120. As shown in FIG. 12, each time the phrase “suggested” is found in the form 10, the interface application highlights or otherwise marks (e.g., bolds, underlines, changes font color, etc.) the located phrase in the form 10 (see highlighted text 140). A user can use the negative phrases check to locate, verify, and modified if necessary each use of selected phrase(s) in the form 10. In some embodiments, the interface application 34 also provides replacement phrases for one or more of the negative phrases located in the form 10. For example, the interface application 34 can display a list similar to the list 60 that contains replacement phrases for a currently highlighted negative phrase located in the form 10. If a user selects a replacement phrase from the list, the interface application 34 replaces the currently highlighted negative phrase with the selected replacement phrase. In other embodiments, the interface application 34 automatically replaces located negative phrases with acceptable replacement phrases.

In some embodiments, a user can use the interface application 34 and/or the editor application 36 to edit the phrases located during a dual phrases or a negative phrases check and/or to edit the replacement phrases suggested for located negative phrases. The dual phrases, negative phrases, and replacement phrases can be stored in the database 44 or a separate database (e.g., a phrases database) and can be assigned to particular users or groups of users. By placing the phrases in a central storage location, a user, such as an administrator, can modify the phrases that will be used by multiple users without having to individually edit or monitor each user's use of the report generation application. In some embodiments, a user can edit the phrases over a network, such as through a browser-based application, which allows an authorized user to make modifications at any location and from any computing device.

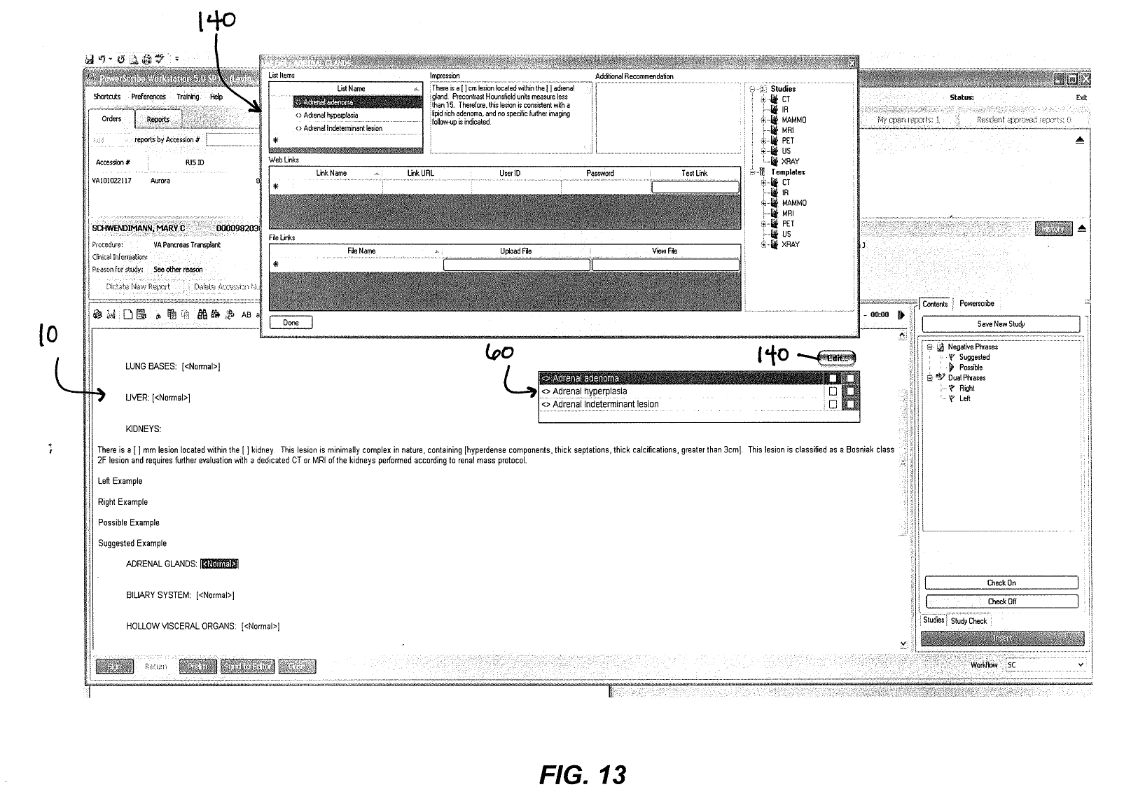

In addition to customizing checks performed by the interface application 34, a user may also be able to edit and customize the potential inputs included in a list 60 for a particular prompt. For example, FIG. 13 is a screen shot illustrating a list editor presented to a user by the interface application 34 and/or the editor application 36 that allows a user to edit a list 60 of potential inputs presented in response to a particular prompt or add a list 60 for a particular prompt. As shown in FIG. 13, a list 60 presented to a user can include an edit selection mechanism 140. If a user selects the edit selection mechanism 140, the interface application 34 and/or the editor application 36 generates a list editor window 142 and displays the list editor window 142 to the user. In some embodiments, the editor window 142 is displayed overlaying the window containing the form 10. The user can use the list editor window 142 to modify the potential inputs associated with the currently active prompt (i.e., the potential inputs listed in the currently displayed list 60). The user can also use the list editor window 142 to edit the links accessible through the links selection mechanism 63, the documents accessible through the documents selection mechanism 64, and/or the tools accessible through tools selection mechanism 65 for the currently displayed list 60. In some embodiments, a user can also access the lists, links, documents, or tools associated with other studies or templates and copy potential inputs, links, documents, or tools from other lists into the currently displayed list 60.

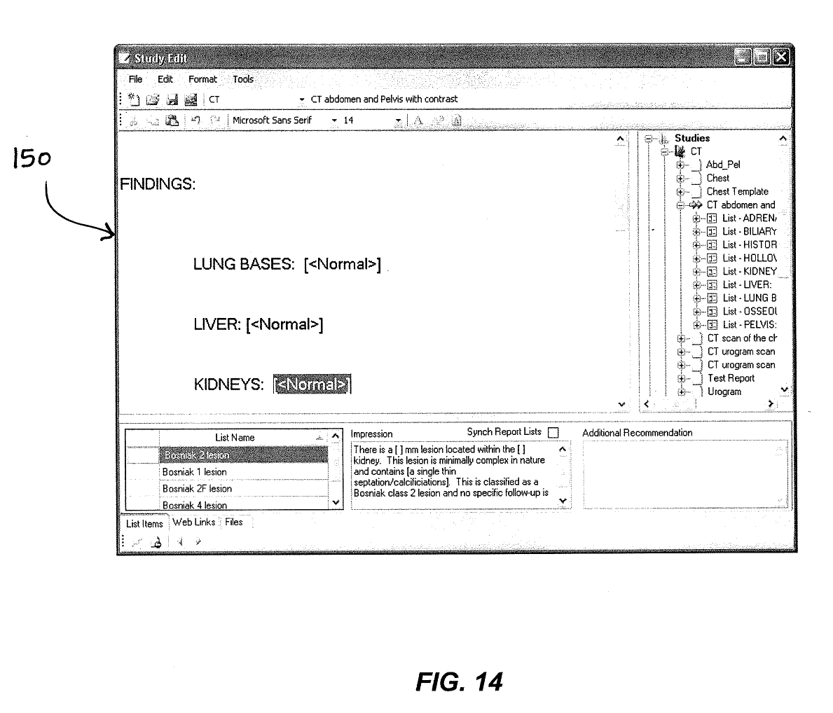

The user can also use the interface application 34 and/or the editor application 36 to edit or customize the interface application 34 and/or the report generation application 40. For example, FIG. 14 is a screen shot illustrating a study editor 150 that allows the user to edit a study and one or more templates associated with a particular study. The new or modified studies and/or templates can be stored in the database 44, the report database 42, and/or locally on a user's workstation or personal computer.

Various features and advantages of the invention are set forth in the following claims.

What is claimed is:

1. A system for providing a list of potential inputs to a user in response to a prompt presented to the user, the system comprising:
a processor;
a database connected to the computer processor and storing information relating to at least one potential input associated with each of a plurality of potential prompts; and
a first application stored in non-transitory computer readable medium accessible and executable by the processor, the first application configured to automatically determine an active location on a text-based form presented to a user by a second application, determine a prompt presented to the user on the text-based form based on the determined active location, generate a list of potential inputs for the determined prompt based on the determined prompt and the information stored in the database, and present the list of potential inputs to the user.

2. The system of claim 1, wherein the first application is further configured to receive a selection of an input from the list of potential inputs from the user and to insert the selected input into the text-based form as plain text.

3. The system of claim 1, wherein the second application includes a radiology report generation dictation application.

4. The system of claim 1, wherein the first application determines the active location by obtaining a handle to a window generated by the second application that displays the text-based form.

5. The system of claim 4, wherein the first application determines the active location by determining highlighted text within the text-based form using the handle.

6. The system of claim 5, wherein the first application determines the highlighted text by intercepting a message from the second application using the handle, the message indicating that a portion of the text-based form is highlighted.

7. The system of claim 5, wherein the first application determines the highlighted text by determining coordinates of the highlighted text.

8. The system of claim 7, wherein the first application determines the highlighted text by extracting a portion of the text-based form based on the coordinates of the highlighted text.

9. The system of claim 8, wherein the first application determines the prompt by applying regular expression logic to the extracted portion of the text-based form.

10. The system of claim 7, wherein the first application presents the list of potential inputs at a location based on the coordinates of the highlighted text.

11. The system of claim 1, wherein the first application generates the list of potential inputs by identifying at least one of the plurality of potential prompts stored in the database as associated with the determined prompt and generating the list of potential inputs based on the potential input associated with the at least one identified potential prompt.

12. The system of claim 11, further comprising a third application configured to receive an update to the at least one database from a user, the update including at least one of a modified potential prompt and a modified potential input.

13. The system of claim 12, wherein the first application receives the update over at least one network.

14. The system of claim 1, wherein the list of potential inputs includes a drop-down list.

15. The system of claim 1, wherein the first application presents the list of potential inputs to the user in a window overlaying a window displaying the text-based form generated by the second application.

16. The system of claim 1, wherein the first application is further configured to display at least one of a link, a document, and a tool to the user based on the determined prompt.

17. The system of claim 16, wherein the at least one of a link, a document, and a tool includes a calculator.

18. The system of claim 1, wherein the first application is further configured to automatically identify at least one phrase included in the text-based report and highlight the at least one phrase in the text-based report for verification by a user.

19. The system of claim 18, wherein the at least one phrase includes at least one of the phrase “right” and “left.”

20. The system of claim 18, wherein the at least one phrase includes a negative phrase and wherein the first application is further configured to display a list of at least one replacement phrase to the user for the negative phrase.

21. The system of claim 20, further comprising a phrase database storing a plurality of negative phrases and a replacement phrase associated with each of the plurality of negative phrases.

22. The system of claim 21, wherein the first application accesses the phrase database and compares text included in the text-based report to the plurality of negative phrases to identify the at least negative phrase.

22. The system of claim 22, wherein the first application is further configured to receive an update to the phrase database from a user, the update including at least one of a modified negative phrase and a modified replacement phrase.

23. The system of claim 22, wherein first application receives the update over at least one network.

24. A computer-implemented method for providing a list of potential inputs to a user in response to prompt presented to the user, the method comprising:
determining, by a processor, an active location on a text-based form presented to a user by a report generation application;
determining, by the processor, a prompt presented to the user on the text-based form based on the determined active location;
generating, by the processor, a list of potential inputs based on the determined prompt; and
presenting, by the processor, the list of potential inputs to the user.

25. The computer-implemented method of claim 24, further comprising receiving a selection of an input from the list of potential inputs from the user and inserting the selected input into the text-based form as plain text.

26. The computer-implemented method of claim 24, wherein the determining the active location includes obtaining a handle to a window displaying the text-based form generated by the report generation application.

27. The computer-implemented method of claim 26, wherein the determining the active location includes determining highlighted text within the text-based form using the handle.

28. The computer-implemented method of claim 27, wherein the determining the highlighted text includes intercepting a message from the report generation application using the handle, the message indicating that a portion of the text-based form is highlighted.

29. The computer-implemented method of claim 27, wherein the determining the highlighted text includes determining coordinates of the highlighted text.

30. The computer-implemented method of claim 29, wherein the determining the highlighted text includes extracting a portion of the text-based form based on the coordinates of the highlighted text.

31. The computer-implemented method of claim 30, wherein the determining the prompt includes applying regular expression logic to the extracted portion of the text-based form.

32. The computer-implemented method of claim 29, wherein the presenting the list of potential inputs includes presenting the list of potential to the user at a location based on the coordinates of the highlighted text.

33. The computer-implemented method of claim 24, wherein the generating the list of potential inputs includes accessing at least one database storing a plurality of potential prompts and a potential input associated with each of the plurality of potential prompts.

34. The computer-implemented method of claim 33, wherein the generating the list of potential inputs includes identifying at least one of the plurality of potential prompts stored in the database as associated with the determined prompt and generating the list of potential inputs based on the potential input associated with the at least one identified potential prompt.

35. The computer-implemented method of claim 33, further comprising receiving an update to the at least one database from a user, the update including at least one of a modified potential prompt and a modified potential input.

36. The computer-implemented method of claim 35, wherein the receiving the update includes receiving the update over at least one network.

37. The computer-implemented method of claim 24, wherein the presenting the list of potential inputs includes displaying a drop-down menu to the user including the list of potential inputs.

38. The computer-implemented method of claim 24, wherein the presenting the list of potential inputs includes displaying the list of potential inputs in a window overlaying a window displaying the text-based form.

39. The computer-implemented method of claim 24, further comprising displaying at least one of a link, a document, and a tool to the user based on the determined prompt.

40. The computer-implemented method of claim 39, wherein the presenting the user with at least one of a link, a document, and a tool includes presenting the user with a calculator.

41. The computer-implemented method of claim 24, further comprising automatically identifying at least one phrase included in the text-based report and highlighting the at least one phrase for verification by a user.

42. The computer-implemented method of claim 41, wherein the automatically identifying the at least one phrase includes automatically identifying at least one of the phrase “right” and “left” in the text-based report.

43. The computer-implemented method of claim 41, wherein the automatically identifying the at least one phrase includes automatically identifying at least one negative phrase included in the text-based report and displaying a list of at least one replacement phrase for the at least one negative phrase.

44. The computer-implemented method of claim 43, further comprising accessing at least one database storing a plurality of negative phrases and a replacement phrase associated with each of the plurality of negative phrases and comparing text included in the text-based report to the plurality of negative phrases to identify the at least one negative phrase.

45. The computer-implemented method of claim 44, further comprising receiving an update to the at least one database from a user, the update including at least one of a modified negative phrase and a modified replacement phrase.

46. The computer-implemented method of claim 45, wherein the receiving the update includes receiving the update over at least one network.

47. Non-transitory computer-readable medium encoded with a plurality of processor-executable instructions for:
determining an active location on a text-based form presented to a user by a report generate application;
determining a prompt presented to the user on the text-based form based on the determined active location;
generating a list of potential inputs based on the determined prompt;
presenting the list of potential inputs to the user;
receiving a selection of an input from the list of potential inputs from the user; and
inserting the selected input to the text-based form as plain text.
